(19) United States
(12) Patent Application Publication
(10) Pub. No.: US 2009/0100240 A1
(43) Pub. Date: Apr. 16, 2009

(54) AUTHENTICATION METHOD, CORRESPONDING PORTABLE OBJECT AND COMPUTER SOFTWARE PROGRAM

(75) Inventor: David Naccache, Paris (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: Compagnie Industrielle Et Financiere D'Ingenierie "Ingenico", Neuilly Sur Seine (FR)

(21) Appl. No.: 12/249,409

(22) Filed: Oct. 10, 2008

(30) Foreign Application Priority Data
Oct. 12, 2007 (FR) 07/58292

(51) Int. Cl. G06F 12/14; H04L 9/32

(52) U.S. Cl. 711/163; 726/16; 711/E12.093

(57) ABSTRACT

A method is provided for authenticating a carrier of a portable object having a memory for memorising at least one item of secret information. The method includes: authentication processing of a signature provided by said carrier, taking account of said secret information; supplying an item of information for the authentication decision, positive or negative, implementing, in a non volatile memory of said portable object, an incorrect signature indicator which may adopt a value indicating a normal situation and at least one value indicating an abnormal situation. The step of implementing including: after said information supplying step, writing, in said incorrect signature indicator, a value indicating an abnormal situation, if said authentication decision is negative; and before said authentication step, and if said incorrect signature indicator contains a value indicating an abnormal situation, a step generating a delay. The writing step also includes memorising at least one item of context-related information.

### CROSS-REFERENCE TO RELATED APPLICATIONS

None.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The disclosure concerns the field of secure portable objects, such as microprocessor cards, or chip cards. More precisely, the disclosure concerns the authentication of the carriers, or users, of such portable objects, and the combat against fraudulent attempts, by malicious persons trying to use a secure portable object of which they are not the holders.

### BACKGROUND OF THE DISCLOSURE

Below the use of chip cards will be described as payment cards. Other applications, such as the access to a site or a service, are of course also known, and dealt with in the same way. Similarly, it is understood that the notion of chip card may be generalized to other types of portable objects equipped with a secure microprocessor.

Chip cards are known and are today widely used. When a chip card is used as a payment card, the authorized user (the holder) of the chip card may use it for example to purchase goods in a shop or to withdraw cash from an automatic cash dispenser.

When the chip card is used to carry out such an operation, it is generally necessary for the authorized user to place his/her chip card in a payment terminal and enter his/her secret code using a keypad of the payment terminal.

This secret code is also called a signature, personal identification number (PIN) or secret code. The secret code associated to a chip payment card is generally composed of a series of at least four digits.

An item of secret information is furthermore stored (memorized) in a memory of the chip card. A verification (mathematical processing) is carried out in the chip card, taking into account (at least) this secret information and the secret code. Consequently, when the code entered on the keypad (signature) matches the secret information memorized in the chip card, the card provides a positive authentication result and authorizes, for example, secure electronic transactions.

One problem is that a chip card is vulnerable to attacks from a malicious third party (fraud) who could, for example after stealing the chip card, try to enter on the keypad a large number of successive combinations of code to find the secret code of the card.

Different solutions to this problem have been proposed. The most well-known is undoubtedly that which uses a counter in a memory of the chip card which memorizes the number of incorrect attempts to enter the secret code in a predetermined lapse of time. Consequently, the use of the chip card is blocked when the number of successive incorrect attempts during this predetermined lapse of time reaches a predetermined threshold value.

One disadvantage of this solution is that the fraudulent person may interrupt the power supply to the chip card in order to reset the counter and power the chip card again in order to carry out new attempts to find the secret code, and so on.

A complementary or alternative solution to the previous one consists in imposing a predetermined time delay between two attempts to enter a code, when the first attempt is incorrect, in order to slow down the fraudulent person in his/her search for the secret code by successive attempts and therefore to reduce the probability that the secret code is discovered by a fraudulent person. However, it may be envisaged that the fraudulent person accelerates the external clock which pilots the chip card in order to reduce the time required between two successive attempts to enter a code.

In the case where the time during which the chip card is powered is shorter than the timing delay between two successive attempts to enter a code (when the first attempt is incorrect), the fraudulent person may also temporarily interrupt the power supply to the chip card after the first attempt and thus reduce the time required between two successive attempts to enter a code.

### SUMMARY

An aspect of the disclosure relates to a method of authenticating a carrier of a portable object comprising a memory for memorising at least one item of secret information, comprising the following steps:
authentication processing of a signature provided by said carrier, taking account of said secret information;
supply of an item of information for the authentication decision, positive or negative,

the method implementing, in a non volatile memory of said portable object, an incorrect signature indicator that may adopt a value indicating a normal situation and at least one value indicating an abnormal situation, and comprising:
after said information supply step, a step for writing, in said incorrect signature indicator, a value indicating an abnormal situation, if said authentication decision is negative; and
before said authentication step, and if said incorrect signature indicator contains a value indicating an abnormal situation, a step generating a delay.

According to an aspect of the present disclosure, said writing step also comprises an operation for memorising at least one item of context-related information, such as the date and time and/or an identifier of the terminal used.

Consequently, an aspect of the present disclosure permits the slowing down of the attempts of a fraudulent person that has the intention of successively entering a series of signatures, in order to find the correct signature, permitting a carrier to be authenticated. Indeed, even if the fraudulent person switches off the power supply to the portable object, the latter has memorized the existence of a possible fraudulent attempt, and will systematically impose a delay, before allowing a new attempt.

The delay may be a function of context-related information, such as the date and time and/or an identifier of the terminal used, which is memorized in the portable object.

In other terms, an aspect of the present disclosure allows the authentication of a carrier of a portable object to be delayed when the signature previously provided does not correspond to the secret information associated to the portable object, and thus reduces the probability that a fraudulent person may discover, by successive attempts, the secret information stored in the portable object, by increasing the time between two attempts, without the possibility of bypassing or avoiding this delay.

According to one specific aspect of the disclosure, the method comprises, after said delay generation step or after said information supply step, a step for writing, in said incorrect signature indicator, said value indicating a normal situation.

Consequently, an aspect of the present disclosure allows fraudulent persons to be dissuaded, without causing too great an inconvenience for the authorized user, who may simply have made a typing error.

According to one specific aspect of the present disclosure, said incorrect signature indicator is a binary element.

According to another specific aspect of the present disclosure, said incorrect signature indicator is a counter that is reset in the presence of a positive authentication decision and incremented in the presence of a negative authentication decision.

Consequently, the incorrect signature indicator that is allocated in a non volatile memory of the portable object may be either a binary element, or a counter, which makes possible a simple, relatively inexpensive and reliable implementation.

In particular, said delay may be proportional to the value of said counter.

Consequently, the delay applied by the portable object may be progressively increased, so as to increase the difficulty for the fraudulent person.

The present disclosure also concerns a computer software program stored on a computer readable support and/or executable by a microprocessor, comprising program code instructions to execute the steps of the authentication method described above.

Finally, the disclosure concerns a secure portable object adapted to the implementation of the method described above and which comprises:
means of memorising at least one item of secret information;
means of authenticating a signature provided by said carrier, taking account of said secret information;
means of supplying an item of authentication decision information, positive or negative, comprising non volatile means for memorising an incorrect signature indicator that may adopt a value indicating a normal situation and at least one value indicating an abnormal situation;
means of memorising of at least one item of context-related information, such as the date and time and/or an identifier of the terminal used.

According to one specific aspect of the disclosure, said portable object comprises:
means of writing, in said incorrect signature indicator, a value indicating an abnormal situation, if said authentication decision is negative; and
means of generating a delay, if said incorrect signature indicator contains a value indicating an abnormal situation.

According to yet another specific aspect of the disclosure, said non volatile memory of the portable object is a EEPROM or Flash type memory.

### BRIEF DESCRIPTION OF THE DRAWINGS

Other features and advantages of the disclosure will become clearer upon reading the following description of two specific embodiments, provided simply by way of example and in no way restrictively, and the appended drawings, among which:
FIG. 1 illustrates an example of a system according to one specific aspect of the disclosure;
FIG. 2 presents the main steps of the authentication method according to a first embodiment;
FIG. 3 presents the main steps of the authentication method according to a second embodiment.

### DETAILED DESCRIPTION OF ILLUSTRATIVE EMBODIMENTS

### 1. General Principle

The general principle of an aspect of the present disclosure is based on the use of an incorrect signature indicator memorized in a non volatile memory of a portable object, which therefore cannot be modified by interrupting the power supply. The value of the indicator commands, according to an aspect of the disclosure, the duration of the method of authenticating a carrier of the portable object, by imposing a delay, systematically if the previous authentication attempt had provided an incorrect result.

### 2. Example of a System Implementing an Aspect of the Present Disclosure

In the following description, the context is a specific aspect of the disclosure, in relation to FIG. 1, according to which the portable object is a chip card 7, that is a payment card issued by a bank, which communicates with a payment terminal 2 (chip card reading terminal).

The carrier of the chip card 7, who may be either the authorized user of the chip card 7 or a fraudulent person, wishes to access a banking service which requires that the person is authenticated beforehand by means of the payment terminal 2. For example, this service may be the payment of a product or a service by the carrier to a shop by means of the chip card 7 via the payment terminal 2.

The payment terminal 2 may be connected to a remote server 1, which is for example located in a bank, via a communication network 9 which thus permits the exchange of information between the payment terminal 2 and the server 1. The remote server 1 which belongs to the bank authorizes secure electronic transactions and may be connected to several payment terminals.

Usually, the payment terminal 2 is electrically powered by an electrical distribution network and/or by one or several batteries integrated into the payment terminal 2. The payment terminal 2 generally has a display screen 5, a numerical or alpha-numerical keypad 3, a card reader 4, a central processing unit (CPU) and a printer (not shown).

The chip card 7 comprises a plastic type support 6 and at least one integrated circuit (chip) 8 that is generally located in the body of the card 7. The integrated circuit 8 of the chip card 7 comprises an interface 12, which is generally in the form of electrical contacts made of copper, permitting the payment terminal 2 to be electrically powered and information to be exchanged, in the form of electrical signals, when the card is inserted in the card reader 4 of the payment terminal 2.

In order for the carrier of the chip card 7 to be able to obtain an authorisation from the bank which has issued the chip card 7 to make a payment, the carrier must be authenticated as the holder of the chip card 7 or the authorized user.

For this purpose, the carrier inserts the chip card 7 in the card reader 4 of the payment terminal 2 provided by the shop and enters his/her secret code (signature) by means of the keypad 3 of the payment terminal 2.

The microprocessor of the chip card 7 carries out a comparative processing operation, or authentication, according to a control algorithm that is known to a person skilled in the art, taking account of the code provided by the carrier by means of the keypad 3 and the secret information derived from the secret code contained in a ROM memory of the chip card 7, and if applicable a random item of data provided by the payment terminal 2. The microprocessor of the chip card 7 then provides the payment terminal 2 an item of authentication decision information, depending on whether the signature provided is correct or incorrect.

When the secret information memorized in the chip card 7 matches the signature provided by the carrier, the secure electronic transactions (or any other operation) are authorized, controlled by the terminal 2 and/or the remote server 1.

The chip card usually comprises a microprocessor and different RAM and ROM memories. It also comprises, according to an aspect of the disclosure, a non volatile modifiable memory, for example an EEPROM 14.

An aspect of the disclosure thus proposes to use an incorrect signature indicator (I), which may be a binary element, such as a memory bit. The binary element is memorized in the EEPROM memory 14 of the chip card 7. The binary element may also be stored in a Flash type memory or any other type of non volatile memory.

### 3. First Example of Implementation

In relation to FIG. 2, the main steps are presented below of a method of authenticating a carrier of a portable object according to a first specific aspect of the disclosure. The context is then a configuration where the chip card 7 is inserted in the card reader 4 of the payment terminal 2.

As illustrated in FIG. 2, the authentication method according to an aspect of the disclosure starts by a new step, which does not exist in the techniques of the prior art, which is to say the reading (21) of the incorrect signature indicator, hereafter called I, in the position of the EEPROM memory 14 that is allocated to it. Depending on the value of this indicator I (test 22), the chip card 7 decides itself (which is say without the intervention or the control of the payment terminal 2) whether or not to apply a delay, before carrying out the usual authentication processing.

Consequently, in the hypothesis where a value 0 of the indicator I signals a correct situation, and the value 1 an abnormal situation, the “yes” output (221) from the test “I=0” (22) permits a direct passage, without delay, to the usual authentication step (23), that will compare the signature S provided by the user by means of an adapted interface (for example a keypad) to the data present in the chip card 7. This processing, which is known and applied in all chip cards, is not described in further detail here. A person skilled in the art would know, according to the circumstances, how to apply the suitable authentication algorithm.

In return, in the case where the indicator I is equal to 1, the “No” output (222) from the test (22) leads to a delay (24) being generated which may be for example between 10 and 60 seconds. At the end of this delay (24), the value of the indicator I is repositioned to 0(step 25), then the usual authentication processing is continued (23).

This authentication processing (23) provides an item of information that is representative of the result of the authentication. If the authentication is validated (test 26), the transaction (27) may be carried out, as usual. This transaction may be a payment, an authorisation to access data or a site, etc. If the authentication is incorrect (261), the payment terminal 2 implements adapted processing (28), that is not the subject of this disclosure. It may for example count the number of authentication errors, and prevent, for example, more than three attempts being made. However, as this processing is carried out by the payment terminal 2, it may easily be bypassed or cancelled by a fraudulent person who would have adapted his/her terminal to be able to enter a very high number of signatures without restriction, for example randomly, in the hope of finding the right signature in a reasonable lapse of time.

This is why, according to an aspect of the disclosure, before carrying out this processing (28) the value 1 is written (29) in the indicator I of the chip card 7.

Consequently, even in the case where the fraudulent person has adapted his/her payment terminal 2, or in the case where he/she has several terminals that are planned to be used successively, this person will be confronted by a wait delay, generated by the chip card 7 itself, preventing an automated series of signature attempts in a reasonable length of time.

The delay applied is selected so that it is sufficiently long to dissuade fraudulent persons, without causing too much inconvenience for the authorized user, who may have simply made a typing error.

### 4. Second Example of Implementation

According to one variant of the method described above, it may be provided that the indicator I is not a simple binary element, indicating if the previous signature was incorrect or valid, but a counter, which counts the number of successive incorrect signatures. This may allow the delay applied by the chip card 7 to be increased progressively, so as to limit the inconvenience for the authorized user, and increase the difficulty for the fraudulent person. This counter may also permit, where applicable, when it has reached a threshold, the chip card 7 to be blocked definitively (again, which it manages itself, instead of the terminals managing this).

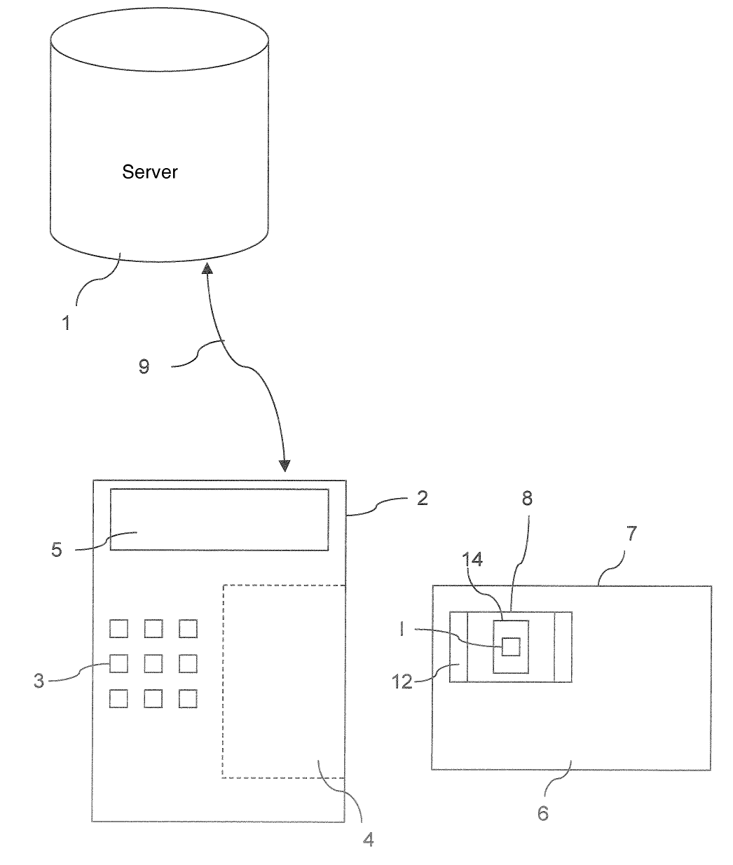

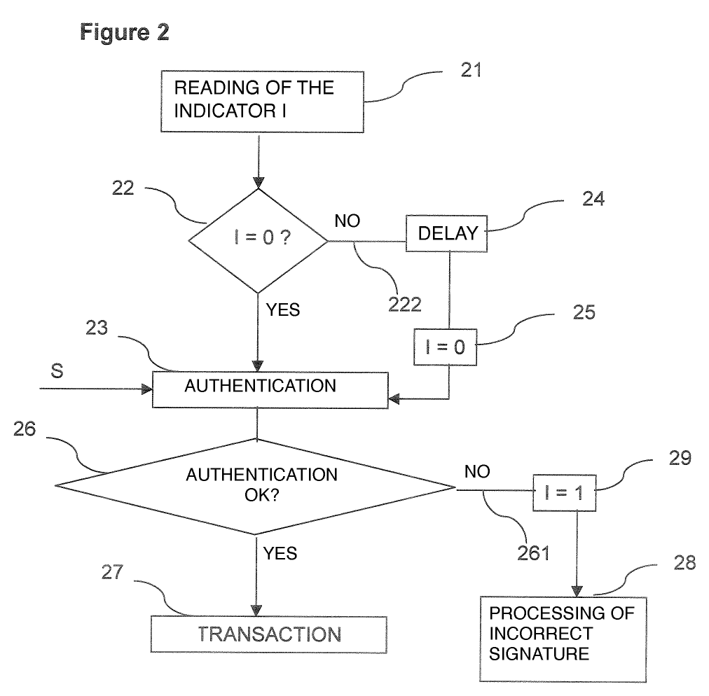

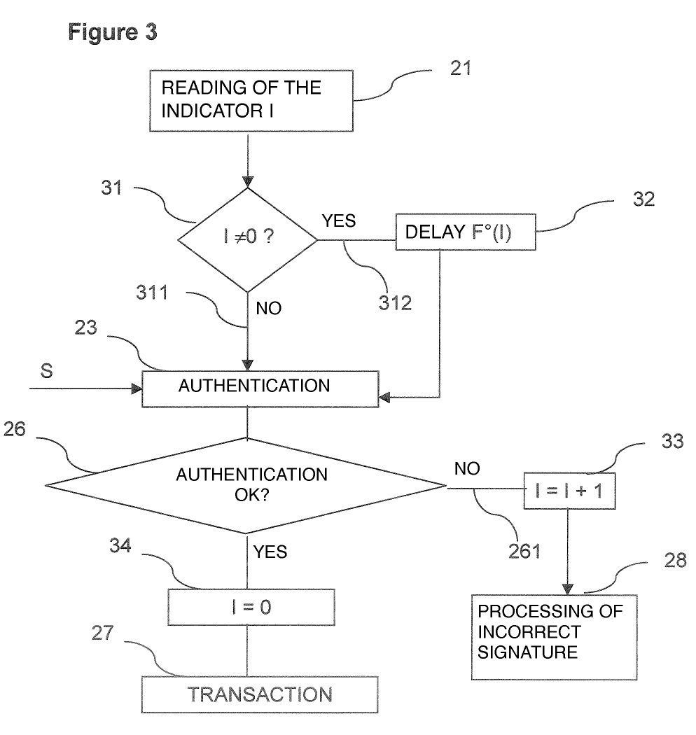

This approach is illustrated in FIG. 3. The method starts in the same manner as in the first embodiment, by reading (21) the indicator I. A test (31) is carried out on the value of the latter. If it is equal to 0, the authentication processing (23) is carried out in the same way as in the first embodiment. If the result of the test (31) indicates (312) that the value of I is different from 0, the chip card 7 generates a delay (32), during which it will not carry out any processing. This delay is no longer fixed, but a function of the value of I. It is possible to provide, for example, a linear function, a threshold function, or an exponential function.

Once the delay (32) is complete, the authentication step (23) is carried out, and the test (26) is then carried out on the result of the authentication. If the result of this test (26) is correct, which is to say that the signature provided has been authenticated, then the value of the indicator is repositioned (34) to 0, then the transaction (27) is carried out.

In return, if the result of the authentication (26) is negative (261), the value of I is incremented (33), before the incorrect signature (28) is processed in the terminal.

### 5. Variants

If the authentication is not correct (261), the writing operation (29, 33) in the indicator I of the chip card 7 may also comprise a memorising operation in a non volatile memory (EEPROM 14 for example) of the chip card 7 of at least one item of context-related information, such as the date and time and/or an identifier of the payment terminal used. The step 21 for reading the indicator I may comprise a step for reading the context-related information that may be memorized in the chip card 7 and the delay (24, 32) may be a function of this information.

In other embodiments, the portable object may be a USB stick and the electronic terminal may be a portable computer or a personal computer for example.

The signature may be entered by other means than a keypad (touch-sensitive screen, voice command, etc.).

The connection between the terminal and the portable object may be made by contact or remotely (RFID for example).

An aspect of the disclosure may also be applied to any situation which requires a restriction to the access to a protected site or premises, to a vehicle belonging to one or several people, an internet site or a database, for example.

An aspect of the disclosure therefore provides a technique to combat the attempts of fraudulent use of a chip card, or a similar portable object.

An aspect of the disclosure reduces the probability that a possible fraudulent person discovers the secret code of the chip card by successive attempts in a relatively short lapse of time, regardless of the technical means implemented.

An aspect of the disclosure provides such a technique that is relatively inexpensive, reliable and simple to implement.

Although the present disclosure has been described with reference to one or more examples, workers skilled in the art will recognize that changes may be made in form and detail without departing from the scope of the disclosure and/or the appended claims.

1. Method of authenticating a carrier of a portable object comprising a memory for memorising at least one item of secret information, the method comprising:
authentication processing of a signature provided by said carrier, taking account of said secret information;
supplying an item of information for the authentication decision, positive or negative,
implementing, in a non volatile memory of said portable object, an incorrect signature indicator which may adopt a value indicating a normal situation and at least one value indicating an abnormal situation, and comprising:
after said information supplying step, writing, in said incorrect signature indicator, a value indicating an abnormal situation, if said authentication decision is negative; and
before said authentication step, and if said incorrect signature indicator contains a value indicating an abnormal situation, a step generating a delay,
wherein said writing step also comprises an operation memorising at least one item of context-related information.

2. The method according to claim 1, wherein the method comprises, after said step of generating a delay or after said step of supplying information:
writing, in said incorrect signature indicator, said value indicating a normal situation.

3. The method according to claim 1, wherein said incorrect signature indicator comprises a binary element.

4. The method according to claim 1, wherein said incorrect signature indicator comprises a counter that is reset in the presence of a positive authentication decision and incremented in the presence of a negative authentication decision.

5. The method according to claim 4, wherein said delay is proportional to the value of said counter.

6. A computer software program stored on a computer readable support and comprising program code instructions to execute a method of authenticating a carrier of a portable object comprising a memory for memorising at least one item of secret information, when the program is executed by a microprocessor, the method comprising:
authentication processing of a signature provided by said carrier, taking account of said secret information;
supplying an item of information for the authentication decision, positive or negative,
implementing, in a non volatile memory of said portable object, an incorrect signature indicator which may adopt a value indicating a normal situation and at least one value indicating an abnormal situation, and comprising:
after said information supplying step, writing, in said incorrect signature indicator, a value indicating an abnormal situation, if said authentication decision is negative; and
before said authentication step, and if said incorrect signature indicator contains a value indicating an abnormal situation, a step generating a delay,
wherein said writing step also comprises an operation memorising at least one item of context-related information.

7. A secure portable object comprising:
means of memorising at least one item of secret information;
means of authenticating a signature provided by said carrier, taking account of said secret information;
means of supplying an item of authentication decision information, positive or negative,
non volatile means of memorising an incorrect signature indicator that may adopt a value indicating a normal situation and at least one value indicating an abnormal situation,
means of memorising of at least one item of context-related information.

8. The secure portable object according to claim 7, wherein the object comprises:
means of writing, in said incorrect signature indicator, a value indicating an abnormal situation, if said authentication decision is negative; and
means of generating a delay, if said incorrect signature indicator contains a value indicating an abnormal situation.

9. The secure portable object according to claim 7, wherein said non volatile memory is an EEPROM or a Flash type memory.
